(19) United States
(12) Patent Application Publication
(10) Pub. No.: US 2016/0164098 A1
(43) Pub. Date: Jun. 9, 2016

(54) FLEXIBLE SECONDARY BATTERY, ELECTRONIC DEVICE

(71) Applicant: KONICA MINOLTA, INC., Tokyo (JP)

(72) Inventors: Hidekane Ozeki, Tokyo (JP); Akira Kawakami, Tokyo (JP); Tsukasa Yagi, Hyogo (JP); Kazuhiro Yoshida, Tokyo (JP); Takeshi Hakii, Kanagawa (JP); Toshiya Kondo, Tokyo (JP)

(73) Assignee: Konica Minolta, Inc., Tokyo (JP)

(21) Appl. No.: 14/901,499

(22) PCT Filed: Jun. 26, 2014
(86) PCT No.: PCT/JP2014/067017

§ 371 Date: Dec. 28, 2015

(30) Foreign Application Priority Data
Jun. 28, 2013 (JP) 2013-136626

(51) Int. Cl. H01M 4/62; H01M 10/04; H01M 10/0585; H01M 10/0525; H01M 4/505

(52) U.S. Cl. CPC H01M 4/622; H01M 10/0525; H01M 4/505; H01M 10/0585; H01M 10/0436; H01M 2004/028

(57) ABSTRACT

Provided is a flexible secondary battery that can achieve both flexibility and high capacity. The flexible secondary battery has flexibility and includes a lithium ion secondary battery including: a positive electrode and a negative electrode at least one of which contains a flexibilizer in its active material layer; and a Mn-containing active material contained in the positive electrode, wherein a degree of decompression inside the lithium ion secondary battery is 100 to 1000 Pa.

### TECHNICAL FIELD

The invention relates to a flexible secondary battery having flexibility and various electronic devices, such as image display devices (displays), including the flexible secondary battery.

### BACKGROUND

Image display devices (displays) using an organic electroluminescent element or the like as a light-emitting element are required to be flexible or cableless for mobile applications.

Flexibilization or cablelessness of image display devices also requires flexibilization of their power supply unit.

Heretofore, some structures have been proposed in which an organic electroluminescent element and a secondary battery are used in combination (see, for example, Patent Literatures 1 to 3).

### CITATION LIST

### Patent Literatures

Patent Literature 1: JP 1-204388 A

Patent Literature 2: JP 10-149880 A

Patent Literature 3: JP 2001-82058 A

### SUMMARY OF INVENTION

Currently, lithium ion secondary batteries are mainly used as secondary batteries, and simultaneous achievement of flexibility and high capacity is a major challenge for flexibilization of lithium ion secondary batteries.

Conventional literatures such as Patent Literatures 1 to 3 do not describe a specific configuration for achieving flexibilization of a battery.

For example, Patent Literature 3 describes a sheet-shaped polymer secondary battery that uses a sheet-shaped positive electrode and a sheet-shaped negative electrode and is sealed with an exterior film. However, Patent Literature 3 does not disclose how to configure the sheet-shaped polymer secondary battery to achieve its flexibilization.

Flexibilization of a lithium ion secondary battery usually reduces its capacity by one or more orders of magnitude.

The reason for this is considered to be that the ratio of an active material that contributes to a battery function is reduced by, for example, increasing the amount of a binder (flexibilizer) contained in an active material layer for flexibilization.

Embodiments of the invention provide a flexible secondary battery that can achieve both flexibility and high capacity. Embodiments of the invention provide an electronic device including the flexible secondary battery.

Embodiments of the invention are achieved by the following means.

1. A flexible secondary battery with flexibility including a lithium ion secondary battery including: a positive electrode and a negative electrode at least one of which contains a flexibilizer in its active material layer; and a Mn-containing active material contained in the positive electrode, wherein a degree of decompression inside the lithium ion secondary battery is 100 to 1000 Pa.

2. The flexible secondary battery according to the above 1, wherein the lithium ion secondary battery has a thickness of 1.5 mm or less.

3. The flexible secondary battery according to the above 1 or 2, wherein the active material contained in the positive electrode is at least one selected from Li(Mn, Co, Ni) O₂, LiMnO₂, Li(Li,Mn)₁₋ₓCoₓO₂, and Li₂MnO₃.

4. The flexible secondary battery according to any one of the above 1 to 3, wherein the flexibilizer is an acrylic polymer or a diene polymer.

5. The flexible secondary battery according to any one of the above 1 to 4, wherein the degree of decompression inside the lithium ion secondary battery is 200 to 800 Pa.

6. The flexible secondary battery according to any one of the above 1 to 5, wherein the active material contained in the positive electrode is a lithium-excess oxide containing Mn.

7. An electronic device including a flexible secondary battery with flexibility including a lithium ion secondary battery including: a positive electrode and a negative electrode at least one of which contains a flexibilizer in its active material layer; and a Mn-containing active material contained in the positive electrode, wherein a degree of decompression inside the lithium ion secondary battery is 100 to 1000 Pa, the electronic device being driven by power supplied from the flexible secondary battery.

8. The electronic device according to the above 7, including a light-emitting element including an organic electroluminescent element.

9. The electronic device according to the above 8, wherein the light-emitting element and the flexible secondary battery are joined together by bonding.

10. The electronic device according to the above 8, wherein the light-emitting element and the flexible secondary battery are integrated together by lamination.

Embodiments of the invention may provide a flexible secondary battery including a lithium ion secondary battery including: a positive electrode and a negative electrode at least one of which contains a flexibilizer in its active material layer; and a Mn-containing active material contained in the positive electrode, wherein a degree of decompression inside the lithium ion secondary battery is 100 to 1000 Pa. Such a flexible secondary battery can achieve a high capacity even when having a flexible thin structure.

Embodiments of the invention provide an electronic device including the flexible secondary battery. Such an electronic device is configured to be driven by power supplied from the flexible secondary battery, and therefore its battery is thin and flexible and has a high capacity. Therefore, the electronic device can have a reduced size and can offer a longer operating time.

### BRIEF DESCRIPTION OF DRAWINGS

FIG. 1 is a schematic view (sectional view) showing the structure of a flexible secondary battery in accordance with embodiments of the invention.

FIG. 2 is a schematic view (sectional view) showing the structure of an electronic device in accordance with embodiments of the invention.

FIG. 3 is a schematic view (sectional view) showing the structure of an electronic device in accordance with embodiments of the invention.

### DETAILED DESCRIPTION

Hereinbelow, embodiments of the invention will be described.

It is to be noted that the description will be made in the following order.

### 1. Summary of Invention

### 2. Flexible Secondary Battery

### 3. Electronic Device

### 4. Electronic Device

<1. Summary of Invention>

First, a summary of embodiments of the invention will be described prior to the description of the embodiments of the invention.

A thin lithium ion secondary battery has a structure in which a positive current collector, a positive active material layer, an electrolyte or electrolytic solution, a separator, an electrolyte or electrolytic solution, a negative active material layer, and a negative current collector are stacked on top of each other and externally sealed with a sealant.

The positive active material layer is mainly made of an active material such as lithium oxide, a binder, and an additive.

A conventional lithium ion secondary battery uses PVdF (polyvinylidene fluoride) or the like as a binder contained in its positive active material layer, and uses a conductive agent, such as acetylene black, as an additive contained in its positive active material layer.

As lithium oxide that is a material contained in the positive active material layer, LiCoO₂, Li(Ni,Co,Mn)O₂, or the like is conventionally mainly used.

The negative active material layer is mainly made of an active material such as graphite, a binder, and an additive. If necessary, silicon is added to the negative active material layer.

A conventional lithium ion secondary battery uses SBR (styrene-butadiene latex) or the like as a binder contained in its negative active material layer, and uses a thickener such as CMC (carboxymethyl cellulose) as an additive contained in its negative active material layer.

When the amount of the binder contained in the positive active material layer or negative active material layer is increased, flexibility is increased but the ratio of the active material is reduced so that the capacity of the lithium ion secondary battery is reduced.

A flexible secondary battery in accordance with embodiments of the invention achieves both flexibility and high capacity due to the following configuration changes made to a conventional secondary battery.

(1) The capacity of a positive electrode is increased.

In order to increase the capacity of a positive electrode, a Mn-containing active material is used.

Examples of the Mn-containing positive active material include Li(Mn,Co,Ni)O₂, LiMnO₂, Li(Li,Mn)₁₋ₓCoₓO₂, and Li₂MnO₃.

When the Mn-containing positive active material is used, the positive electrode can have a higher capacity as compared to when a positive active material not containing Mn (e.g., LiCoO₂) is used.

A lithium-excess oxide containing Mn is used as a positive active material.

When Li(Mn,Co,Ni)O₂ or LiMnO₂ is used, a theoretical capacity is about 150 mAh/g.

On the other hand, when a lithium-excess oxide containing Mn, such as Li (Li,Mn)₁₋ₓCoₓO₂ or Li₂MnO₃, is used as a positive active material, a theoretical capacity is increased up to about 250 to 400 mAh/g.

(2) The degree of package decompression is reduced.

In order to allow a secondary battery to have flexibility, a package pressure at which the secondary battery is sealed must be reduced so that the secondary battery can be bent.

The package pressure is reduced to about 30 to 50% of that of a conventional lithium ion secondary battery having no flexibility.

In the flexible battery in accordance with embodiments of the invention, the degree of package decompression of its lithium ion secondary battery is set to 100 to 1000 Pa. The degree of package decompression is in the range of 200 to 800 Pa, or 500 Pa.

A bend radius R as a criterion for flexibility is 100 mm or less, or 30 mm to 3 mm.

In the flexible battery in accordance with embodiments of the invention, the thickness of its lithium ion secondary battery is set to 1.5 mm or less, or 0.5 mm or less.

(3) A binder (flexibilizer) is added to an active material layer. An improved binder (flexibilizer), such as an acrylic polymer or a diene-based polymer, is used as a binder.

The binder (flexibilizer) is used in at least one of a positive active material layer and a negative active material layer.

An acrylic polymer or a diene-based polymer is used as the binder (flexibilizer). The acrylic polymer or the diene-based polymer may form a copolymer with another binder material. When the acrylic polymer or the diene-based polymer is used as the binder (flexibilizer), flexibility can be improved as compared to when another binder material is used.

Examples of a specific material for forming the acrylic polymer or the diene-based polymer include butadiene, PTFE (polytetrafluoroethylene), VDF (vinylidene fluoride), and TFE (tetrafluoroethylene).

A specific example of the binder that can be used is BM-400 manufactured by ZEON CORPORATION.

It is to be noted that the binder contained in the positive active material layer may be acrylic (e.g., acrylate polymer) because of a safety concern.

The configuration, other than the above (1) to (3), of the flexible secondary battery may be similar to that of a conventionally-known thin lithium ion secondary battery.

However, assuming that the secondary battery having flexibility is bent when used, it is desirable that its electrolyte layer be made of such a material that does not cause leakage of an electrolytic solution or that does not cause breakage of the electrolyte layer due to bending of the secondary battery.

An electronic device in accordance with embodiments of the invention includes the flexible secondary battery, and is configured to be driven by power supplied from the flexible secondary battery.

The flexible secondary battery in accordance with embodiments of the invention is thin and has flexibility. Therefore, when the flexible secondary battery in accordance with embodiments of the invention is incorporated into any electronic device as a driving power source, the flexible secondary battery does not occupy a large space and the electronic device can be reduced in size. Further, the flexible secondary battery in accordance with embodiments of the invention can be used in a bent state, and therefore the design flexibility of an electronic device using the flexible secondary battery can be increased.

Further, the flexible secondary battery in accordance with embodiments of the invention has a high capacity due to the configuration changes made to a conventional lithium ion secondary battery. Therefore, an electronic device including the flexible secondary battery in accordance with embodiments of the invention is suitable for use in, for example, the outdoors where no power source is available. For example, the flexible battery in accordance with embodiments of the invention can be used in various so-called mobile devices.

The electronic device in accordance with embodiments of the invention includes the flexible secondary battery, and therefore can have a reduced size and can offer a longer operating time

When the electronic device in accordance with embodiments of the invention is applied to, for example, an IC card, the IC card has a structure in which an antenna or a driving circuit is connected with the flexible battery.

The flexible secondary battery allows an IC card to have a high-capacity battery without increasing the thickness of the IC card.

This makes it possible to achieve a thin IC card having various functions.

When the electronic device in accordance with embodiments of the invention is applied to, for example, a thin display, the entire display including a power supply unit can be made thin by combination of a thin image display unit and the thin flexible secondary battery. Examples of the thin display to which the electronic device in accordance with embodiments of the invention is applied include a liquid crystal display and a display using an organic electroluminescent element.

Particularly, an organic electroluminescent element (OLED) has been proposed which is configured to have flexibility with the use of a transparent flexible film as a substrate. A flexible display can be achieved by using a display using such a flexible organic electroluminescent element and the flexible secondary battery in accordance with embodiments of the invention.

Further, a lighting device has been proposed which is configured to use an organic electroluminescent element (OLED) as a light-emitting element. The electronic device in accordance with embodiments of the invention can also be applied to this lighting device.

Particularly, a lighting device having flexibility as a whole can be achieved by connecting the flexible secondary battery in accordance with embodiments of the invention with an organic electroluminescent element (OLED) that is used as a light emitter of the lighting device and is configured to have flexibility with the use of a transparent flexible film as a substrate.

When the electronic device in accordance with embodiments of the invention is applied to a device using an organic electroluminescent element (OLED), the organic electroluminescent element used has a layered structure. Examples of the layered structure are as follows.
(i) substrate film/positive electrode/hole-injecting layer/hole transport layer/light-emitting layer/electron transport layer/negative electrode
(ii) substrate film/positive electrode/hole-injecting layer/hole transport layer/light-emitting layer/electron transport layer/electron-injecting layer/negative electrode
(iii) substrate film/negative electrode/hole-injecting layer/hole transport layer/light-emitting layer/electron transport layer/hole-blocking layer/negative electrode
(iv) substrate film/positive electrode/hole-injecting layer/hole transport layer/light-emitting layer/electron transport layer/electron-injecting layer/hole-blocking layer/negative electrode
(v) substrate film/positive electrode/hole-injecting layer/hole transport layer/electron-blocking layer/light-emitting layer/electron transport layer/electron-injecting layer/hole-blocking layer/negative electrode

As the substrate film, a resin film having flexibility is used.

Each of the layers of each of the layered structures can be made of a conventionally-known material.

A protective film is formed on the negative electrode in each of the layered structures.

Further, a gas barrier film is formed on the inner surface side of the substrate film or of the protective film.

When the electronic device in accordance with embodiments of the invention is applied to a lighting device using an organic electroluminescent element (OLED) as a light-emitting element, the lighting device can have a structure in which the flexible secondary battery is provided on one of the surfaces of the light-emitting element.

When the lighting device having such a structure is produced, for example, the light-emitting element and the flexible secondary battery are joined together by bonding or integrated together by lamination.

Further, the electronic device in accordance with embodiments of the invention can have a structure in which the flexible battery is combined with a sheet of electronic material, such as a solar cell sheet, that is used as a power source by exposure to light.

When the electronic device in accordance with embodiments of the invention has such a structure, electric energy generated by exposure to light can be stored in the flexible battery.

<2. Flexible Secondary Battery>

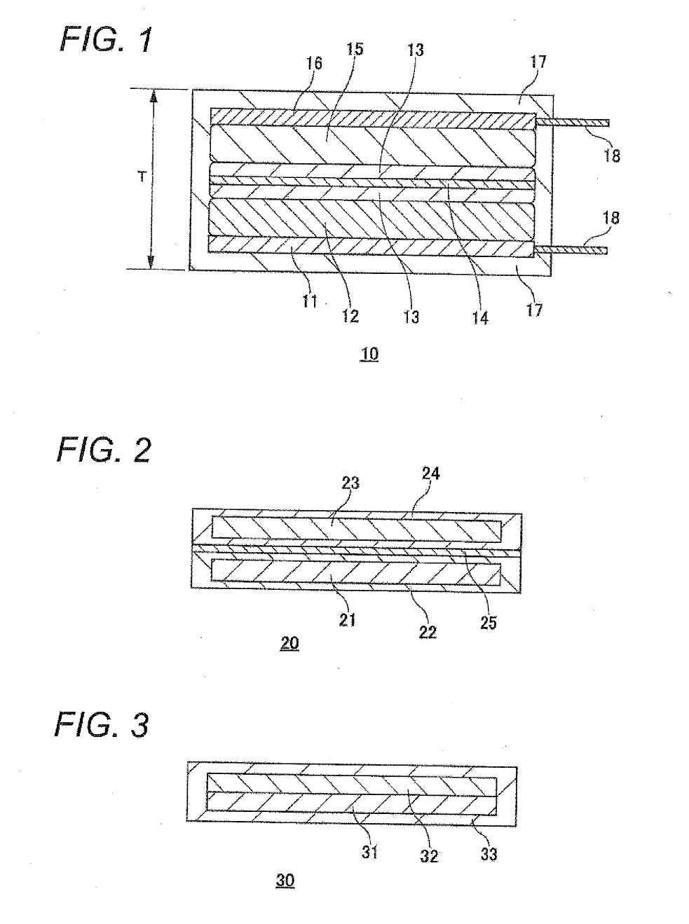

FIG. 1 is a schematic view (sectional view) showing the structure of a flexible secondary battery in accordance with embodiments of the invention.

A flexible secondary battery 10 shown in FIG. 1 has a structure in which a positive current collector 11, a positive active material layer 12, an electrolyte layer 13, a separator 14, an electrolyte layer 13, a negative active material layer 15, and a negative current collector 16 are stacked on top of each other and externally sealed with a sealant 17. The positive current collector 11 and the negative current collector 16 are connected with an extraction tag (electrode terminal) 18, and this extraction tag (electrode terminal) 18 is configured to extend to the outside of the sealant 17.

The positive current collector 11 can use a conventionally-known material for positive current collector, such as Al.

The positive active material layer 12 uses a Mn-containing positive active material, a binder, an additive, etc. As the additive contained in the positive active material layer 12, for example, a conductive agent such as acetylene black can be used.

The electrolyte layer 13 can use an electrolyte such as LiPF₆.

The separator 14 can use, for example, a polyolefin such as polypropylene or polyethylene.

The negative active material layer 15 uses a conventionally-known negative active material, such as graphite, a binder, an additive, etc. As the additive contained in the negative active material layer 15, for example, a thickener such as carboxymethyl cellulose (CMC) can be used.

The negative current collector 16 can use a conventionally-known material for negative current collector, such as Cu.

The sealant 17 can use a conventionally-known material for sealing such as a multi-layered Al and PET (polyethylene terephthalate) film.

Examples of the Mn-containing positive active material for use as a positive active material contained in the positive active material layer 12 include Li(Mn,Co,Ni)O₂, LiMnO₂, Li(Li,Mn)₁₋ₓCoₓO₂, and Li₂MnO₃. A lithium-excess oxide containing Mn, such as Li(Mn,Co,Ni)O₂ or LiMnO₂, is used as the positive active material.

The degree of package decompression inside the sealant 17 is set to 100 to 1000 Pa. The degree of package decompression is in the range of 200 to 800 Pa, or 500 Pa.

The thickness T of the flexible secondary battery 10 including the sealant 17 is set to 1.5 mm or less, or 0.5 mm or less.

At least one of the positive active material layer 12 and the negative active material layer 15 contains a binder (flexibilizer) using an acrylic polymer or a diene-based polymer.

The flexible secondary battery 10 according to this embodiment has a high capacity and sufficient flexibility because the positive active material layer 12 contains a Mn-containing positive active material, the degree of package decompression inside the sealant 17 is 100 to 1000 Pa, and the positive active material layer 12 and/or the negative active material layer 15 contain a binder (flexibilizer).

<3. Electronic Device>

FIG. 2 is a schematic view (sectional view) showing the structure of an electronic device in accordance with embodiments of the invention.

This embodiment is provided by applying the electronic device in accordance with embodiments of the invention to a light-emitting sheet including an organic electroluminescent element (OLED).

A light-emitting sheet 20 shown in FIG. 2 has a structure in which a flexible secondary battery 21 is sealed with a sealant 22, an OLED light-emitting element 23 is sealed with a sealant 24, and the sealant 22 and the sealant 24 are bonded together with a bonding layer 25.

The OLED light-emitting element 23 is provided on the upper side of the flexible secondary battery 21 so that light is emitted from the upper surface of the OLED light-emitting element 23.

The flexible secondary battery 21 can be composed of the flexible battery in accordance with embodiments of the invention. For example, the flexible secondary battery 21 can have a laminated structure similar to the laminated structure between the positive current collector 11 and the negative current collector 16 of the flexible secondary battery 10 in accordance with embodiments of the invention.

The OLED light-emitting element 23 can be composed of a light-emitting element including a conventional sheet-shaped flexible organic electroluminescent element (OLED).

The sealant 22 and the sealant 24 can use a conventionally-known flexible material for sealing. The sealant itself may contain a material having gas barrier properties, or a membrane having gas barrier properties may be formed on the inner side of the sealant.

Although not shown, the flexible secondary battery 21 and the OLED light-emitting element 23 are electrically connected together.

Further, if necessary, a booster circuit may be provided, for example, outside the light-emitting sheet 20 so that the electromotive force of the flexible secondary battery 21 is boosted before supplied to the OLED light-emitting element 23.

It is to be noted that the booster circuit may be provided inside the light-emitting sheet 20 when the booster circuit can be composed of a flexible substrate and a thin-film circuit.

The light-emitting sheet 20 according to this embodiment can emit light because the sealant 22 sealing the flexible secondary battery 21 and the sealant 24 sealing the OLED light-emitting element 23 are bonded together and the flexible secondary battery 21 and the OLED light-emitting element 23 are electrically connected together so that the OLED light-emitting element 23 is driven by the flexible secondary battery 21.

Further, the flexible secondary battery 21 and the OLED light-emitting element 23 are both sheet-shaped and flexible, and therefore the light-emitting sheet 20 can have flexibility. Therefore, the light-emitting sheet 20 can emit light even in a bent state.

<4. Electronic Device>

FIG. 3 is a schematic view (sectional view) showing the structure of an electronic device in accordance with embodiments of the invention.

Some embodiments may also be realided by applying the electronic device to a light-emitting sheet including an organic electroluminescent element (OLED).

A light-emitting sheet 30 shown in FIG. 3 has a structure in which an OLED light-emitting element 32 is stacked on a flexible secondary battery 31, and the OLED light-emitting element 32 and the flexible secondary battery 31 are entirely sealed with a sealant 33.

The OLED light-emitting element 32 is provided on the upper side of the flexible secondary battery 31 so that light is emitted from the upper surface of the OLED light-emitting element 32.

In some embodiments, flexible secondary battery 31 can be composed of the flexible battery. For example, the flexible secondary battery 31 can have a laminated structure similar to the laminated structure between the positive current collector 11 and the negative current collector 16 of the flexible secondary battery 10.

The OLED light-emitting element 32 can be composed of a light-emitting element including a conventional sheet-shaped flexible organic electroluminescent element (OLED).

The sealant 33 can use a conventionally-known flexible material for sealing. The sealant itself may contain a material having gas barrier properties, or a membrane having gas barrier properties may be formed on the inner side of the sealant.

Although not shown, the flexible secondary battery 31 and the OLED light-emitting element 32 are electrically connected together.

The light-emitting sheet 30 according to this embodiment can emit light because the flexible secondary battery 31 and the OLED light-emitting element 32 are stacked on top of each other and the flexible secondary battery 31 and the OLED light-emitting element 32 are electrically connected together so that the OLED light-emitting element 32 is driven by the flexible secondary battery 31.

Further, the flexible secondary battery 31 and the OLED light-emitting element 32 are both sheet-shaped and flexible, and therefore the light-emitting sheet 30 can have flexibility. Therefore, the light-emitting sheet 30 can emit light even in a bent state.

The invention is not limited to the above embodiments, and may be embodied in various forms without departing from the scope of the present invention.

Although the disclosure has been described with respect to only a limited number of embodiments, those skilled in the art, having benefit of this disclosure, will appreciate that various other embodiments may be devised without departing from the scope of the invention. Accordingly, the scope of the invention should be limited only by the attached claims.

### REFERENCE SIGNS LIST

10,21,31 Flexible secondary battery, 11 Positive current collector, 12 Positive active material layer, 13 Electrolyte layer, 14 Separator, 15 Negative active material layer, 16 Negative current collector, 17,22,24,33 Sealant, 18 Extraction tag (Electrode terminal), 20,30 Light-emitting sheet, 23,32 OLED light-emitting element

1.-10. (canceled)

11. A flexible secondary battery comprising:
a positive electrode and a negative electrode at least one of which contains a flexibilizer in its active material layer; and
a Mn-containing active material contained in the positive electrode, wherein a degree of decompression inside the lithium ion secondary battery is 100 to 1000 Pa.

12. The flexible secondary battery according to claim 1, wherein the lithium ion secondary battery has a thickness of 1.5 mm or less.

13. The flexible secondary battery according to claim 1, wherein the active material contained in the positive electrode is at least one selected from Li(Mn,Co,Ni)O₂, LiMnO₂, Li(Li,Mn)₁₋ₓCoₓO₂, and Li₂MnO₃.

14. The flexible secondary battery according to claim 1, wherein the flexibilizer is an acrylic polymer or a diene polymer.

15. The flexible secondary battery according to claim 1, wherein the degree of decompression inside the lithium ion secondary battery is 200 to 800 Pa.

16. The flexible secondary battery according to claim 1, wherein the active material contained in the positive electrode is a lithium-excess oxide containing Mn.

17. An electronic device comprising a flexible secondary battery comprising:
a positive electrode and a negative electrode at least one of which contains a flexibilizer in its active material layer; and
a Mn-containing active material contained in the positive electrode, wherein a degree of decompression inside the lithium ion secondary battery is 100 to 1000 Pa, the electronic device being driven by power supplied from the flexible secondary battery.

18. The electronic device according to claim 7, comprising a light-emitting element comprising an organic electroluminescent element.

19. The electronic device according to claim 8, wherein the light-emitting element and the flexible secondary battery are joined together by bonding.

20. The electronic device according to claim 8, wherein the light-emitting element and the flexible secondary battery are integrated together by lamination.

21. The flexible secondary battery according to claim 2, wherein the active material contained in the positive electrode is at least one selected from Li(Mn,Co,Ni)O₂, LiMnO₂, Li(Li,Mn)₁₋ₓCoₓO₂, and Li₂MnO₃.

22. The flexible secondary battery according to claim 2, wherein the flexibilizer is an acrylic polymer or a diene polymer.

23. The flexible secondary battery according to claim 2, wherein the degree of decompression inside the lithium ion secondary battery is 200 to 800 Pa.

24. The flexible secondary battery according to claim 2, wherein the active material contained in the positive electrode is a lithium-excess oxide containing Mn.

25. The flexible secondary battery according to claim 3, wherein the flexibilizer is an acrylic polymer or a diene polymer.

26. The flexible secondary battery according to claim 3, wherein the degree of decompression inside the lithium ion secondary battery is 200 to 800 Pa.

27. The flexible secondary battery according to claim 3, wherein the active material contained in the positive electrode is a lithium-excess oxide containing Mn.

28. The flexible secondary battery according to claim 4, wherein the degree of decompression inside the lithium ion secondary battery is 200 to 800 Pa.

29. The flexible secondary battery according to claim 4, wherein the active material contained in the positive electrode is a lithium-excess oxide containing Mn.

30. The flexible secondary battery according to claim 5, wherein the active material contained in the positive electrode is a lithium-excess oxide containing Mn.
